(19) United States
(12) Patent Application Publication
(10) Pub. No.: US 2017/0010779 A1
(43) Pub. Date: Jan. 12, 2017

(54) METHOD AND SYSTEM FOR CUSTOMIZABLE FEEDBACK BASED ON DOMINANT MOVEMENT

(71) Applicants: Chase FREEDMAN, Georgetown, MA (US); Charles FREEDMAN, Georgetown, MA (US)

(72) Inventors: Chase FREEDMAN, Georgetown, MA (US); Charles FREEDMAN, Georgetown, MA (US)

(21) Appl. No.: 15/202,647

(22) Filed: Jul. 6, 2016

Related U.S. Application Data
(60) Provisional application No. 62/189,179, filed on Jul. 6, 2015.

(51) Int. Cl. G06F 3/0487; G06F 3/01

(52) U.S. Cl. CPC G06F 3/0487; G06F 3/016; G06F 2203/013; G06F 2203/04808

(57) ABSTRACT

In a method for customizable feedback based on dominant movement of a device, an application receives user action data from the device, determines a dominant movement based on the user action data and the plurality of movement thresholds, and determines a feedback associated with the dominant movement. The associated feedback is then performed. When the application determines that the user action data indicates one or more button presses, the feedback associated with the one or more buttons is determined, and the feedback associated with the one or more button presses is performed. When the user action data does not indicate any button presses, the application determines the dominant movement based on movement data in the user action data, the movement data indicating movement through space in one or more directions by the device.

### CROSS-REFERENCE TO RELATED APPLICATIONS

This application claimed priority to co-pending U.S. provisional patent application no. 62/189,179, filed on Jul. 6, 2015, incorporated herein in its entirety.

### BACKGROUND OF THE INVENTION

Currently, toys with motion-driven sound and interaction, such as the relationship between a Wii™ remote with a Wii™ console, are both limited in range and extensibility of the device in play. For example, with the Wii™ remote, the user has no ability to build around or be creative in how the Wii™ remote is used other than with Wii™ games since the Wii™ is a closed system. These limitations prevent the devices from: reacting specifically to a varying degree of motion, such as distinctively moving up, down, left, right, rolling or spinning right, or rolling or spinning left in 6 directions and other gestures of movement; allowing a user to record their own sounds and share them with others; allowing the user to download other sounds that complement their use of the device; and giving the user an accessory to brick compatible devices that adds motion-interactive play. Examples of brick compatible devices include, but are not limited to Lego™ Kre-o™, and Mega Bloks™.

### BRIEF SUMMARY OF THE INVENTION

Disclosed herein is a method for customizable feedback based on dominant movement and a corresponding system and a computer readable medium as specified in the independent claims. Embodiments of the present invention are given in the dependent claims. Embodiments of the present invention can be freely combined with each other if they are not mutually exclusive.

According to one embodiment of the present invention, a method for customizable feedback based on dominant movement of a device, implemented by a computer system, synchronizes a device and an application implemented by the computer system, where a plurality of movement thresholds is associated with the application. The application receives user action data from the device, where the user action data indicates one or more user actions performed with or on the device. The application determines a dominant movement based on the user action data and the plurality of movement thresholds. The application determines a feedback associated with the dominant movement, where the feedback comprises one or more sensory activities to be performed by the device in response to a given user action. The application then either sends a feedback command to the device to perform the associated feedback or the feedback is executed by the computer system.

In one aspect of the present invention, the application determines that the user action data indicates one or more button presses. In response, the feedback associated with the one or more buttons is determined, and the feedback command is sent to the device to perform the feedback associated with the one or more button presses.

In one aspect of the present invention, when the user action data does not indicate any button presses, the application determines the dominant movement based on movement data in the user action data, the movement data indicating movement through space in one or more directions or gestures by the device.

### BRIEF DESCRIPTION OF THE SEVERAL VIEWS OF THE FIGURES

FIG. 1 illustrates a device and a computer system for customizable feedback based on dominant movement according to embodiments of the present invention.

FIG. 2 illustrates an embodiment of the functions of the device according to embodiments of the present invention.

FIG. 3 illustrates an embodiment of the functions of the application implemented by the computer system according to embodiments of the present invention.

FIG. 4 illustrates the determination of dominant movement according to embodiments of the present invention.

FIG. 5 illustrates an example outer design of the device 100 according to embodiments of the present invention.

### DETAILED DESCRIPTION OF THE INVENTION

The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

Reference in this specification to “one embodiment”, “an embodiment”, “an exemplary embodiment”, or “a preferred embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In general, features described in one embodiment might be suitable for use in other embodiments as would be apparent to those skilled in the art.

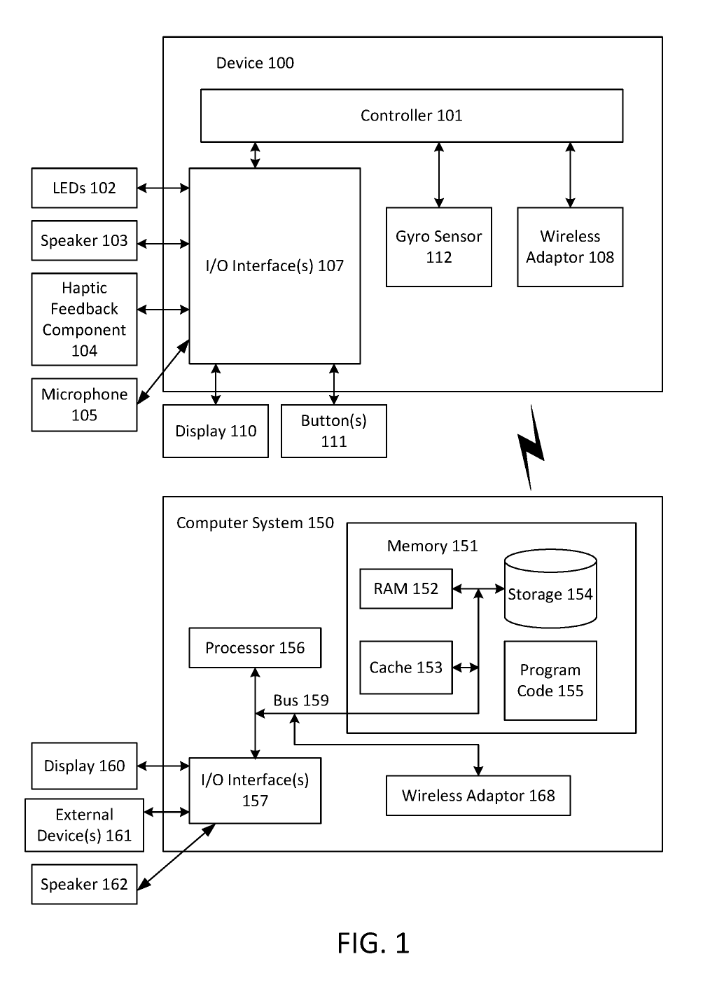

FIG. 1 illustrates a device and a computer system for customizable interaction based on dominant movement according to embodiments of the present invention. The device 100 may be an object with which a user interacts, such as a toy. In the illustrated embodiment, the device 100 comprises a controller 101 that is operationally coupled to one or more sensory feedback components via an input/output (I/O) interface 107, including but not limited to: lights, such as Light Emitting Diodes (LED) 102; a speaker 103; a haptic feedback component 104; a microphone 105; and one or more buttons 111. The controller 101 is further operationally coupled to a gyro sensor 112 for sensing movement of the device 100 in space, such as when the device 100 is physically moved by a user in a three-dimensional space during play. The device 100 is further operationally coupled to and one or more buttons 111, which may be pressed by the user. The “buttons” 111 may be physical press buttons, switches, toggles, or slides, or implemented as icons or other graphics on a touchscreen display. The device 100 may communicate wirelessly with one or more other devices via wireless adapter 108. For example, a Bluetooth™ Low Energy (BLE) component may be used.

The computer system 150 may be another device, such as a mobile device, a smart phone, a tablet, a set top box, or other “smart” device, to which the device 100 communicates. The computer system 150 is operationally coupled to a processor or processing units 156, a memory 151, and a bus 159 that couples various system components, including the memory 151 to the processor 156. The bus 159 represents one or more of any of several types of bus structure, including a memory bus or memory controller, a peripheral bus, an accelerated graphics port, and a processor or local bus using any of a variety of bus architectures. The memory 151 may include computer readable media in the form of volatile memory, such as random access memory (RAM) 152 or cache memory 153, or non-volatile storage media 154. The memory 151 may include at least one program product (an “application”) having a set of at least one program code module 155 that are configured to carry out the functions of embodiments of the present invention when executed by the processor 156. The computer system 150 may also communicate with one or more external devices 161, such as a display 160 and a speaker 162, via I/O interfaces 157. The computer system 150 may communicate wirelessly with the device 100 via wireless adapter 168. For example, a Bluetooth™ Low Energy (BLE) component may be used. Although the device 100 and the computer system 150 are illustrated as separate devices, their functionalities may be combined in a single device.

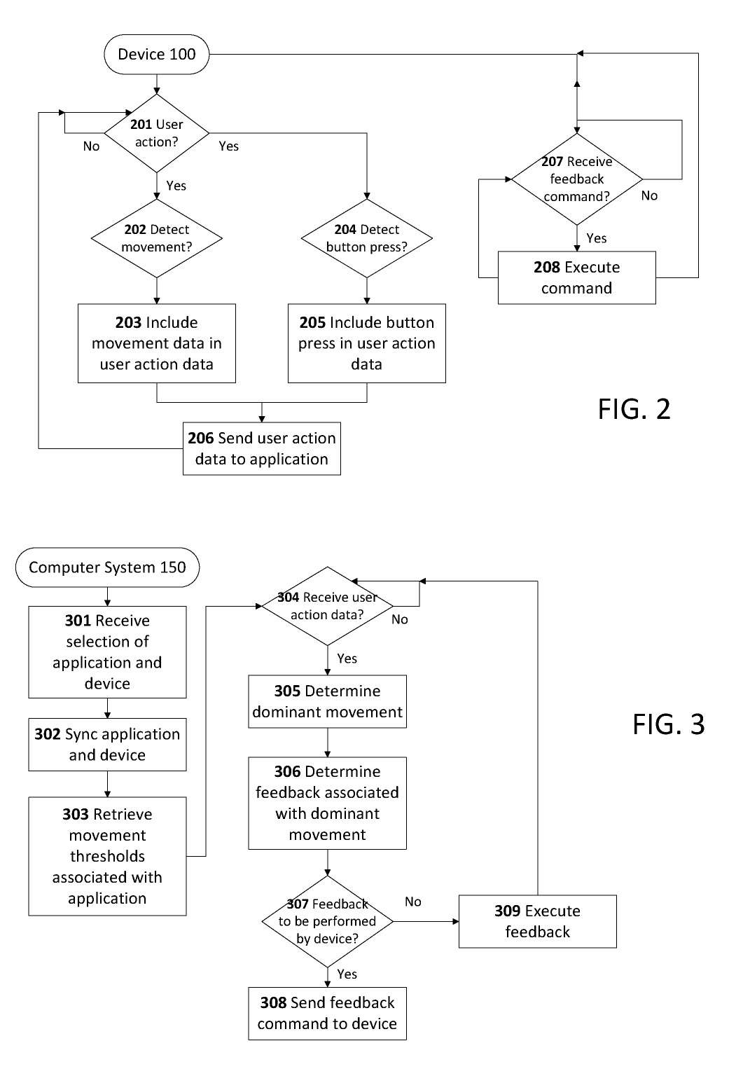

FIGS. 2 and 3 illustrate methods for customizable feedback based on dominant movement according to embodiments of the present invention. FIG. 2 illustrates an embodiment of the functions of the device 100, and FIG. 3 illustrates an embodiment of the functions of the application implemented by the computer system 150. The application receives user action data from the device 100, determines the associated interaction based on the user action data, and sends interaction commands to the device 100 to perform the associated interaction. The controller 101 generates user action data indicating a detection of a button press and/or direction(s) of movement, also referred to as gestures, detected by the gyro sensor 112. Other types of user actions may also be included. A “user action”, as used herein, refers to one or more actions a user of the device 100 performs with or on the device 100, including but not limited to interacting with buttons, displays, or manual movement of the device 100 in space. A “feedback”, as used herein, refers to a sensory action to be performed by the device 100 in response to a given user action. Examples of sensory actions include visual feedback (such as images, graphics, video or lights), auditory feedback (such as sounds), and haptic feedback (such as vibrations). Such feedbacks and their associated user actions may be preloaded into the application or the user may record or set custom feedbacks. Multiple applications may be implemented by the computer system 150, each with its own associations between feedbacks and user actions.

Referring to FIG. 3, the computer system 150 receives a selection of an application for customizable feedback and a device 100 (301). The computer system 150 then synchronizes the application and the device 100 (302), via their respective wireless adaptors 108, 168, and retrieves the movement thresholds associated with the application (303). The application is now ready to receive user action data from the device 100, and the device 100 is ready to receive feedback commands from the application.

Referring to FIG. 2, when the controller 101 of the device 100 detects a user action (201), the controller 101 determines whether the user action includes detection of movement via the gyro sensors 112 (202) and whether the user action includes a button press (204). When the user action includes movement (202), the controller 101 includes the sensor data from the gyro sensors 112 in the user action data (206). When the user action includes a button press (204), the controller 101 includes the button press data in the user action data (205). The controller 101 then sends the user action data to the application at the computer system 150 (206), via the wireless adaptor 108. In this illustrative embodiment, the device 100 sends a constant stream of real-time user action data to the computer system 150, as long as the device 100 is not idle for at least some predetermined period of time. When the device 100 has been idle, and movement is then detected, the streaming of the real-time user action data resumes.

Referring to FIG. 3, when the application receives user action data from the device 100 (304), the application determines the dominant movement based on the user action data and the movement thresholds (305), as described further below. The application then determines the feedback associated with the dominant movement (306). When the feedback is to be performed by the device 100 (307), the application sends a feedback command to the device 100 (308). When the feedback is to be performed by the computer system 150, the application executes the feedback by activating the appropriate component in the computer system 150 (309).

Referring to FIG. 2, when the device 100 receives a feedback command from the application (207), the device 100 executes the command by activating the appropriate component in the device 100 (208).

In the above manner, the computer system 150 constantly evaluates user actions on the device 100, determines the dominant action of play, and drives the feedbacks accordingly. For example, feedback can take the form of playing sounds via the speaker 103 or 162, moving a two-dimensional or three-dimensional object on a display 110 or 160, controlling lights 102, or cause a vibration via the haptic feedback component 104. For example, when movement in one given direction is detected, the feedback can take the form of flashing the LED lights 102 by the device 100, playing certain sounds through the speaker at the device 103 and/or the computer system 150, or its speakers 162, and/or display an object on the display 110 at the device 100 or the display 160 at the computer system 150. When movement in another given direction is detected, the feedback command from the application may cause the device 100 to cause the haptic feedback component 104 to vibrate and an image to display on the display 110.

In this illustrative embodiment, the gyro sensors 112 registers movement on a fixed world coordinate system. In the illustrative embodiments, the movements may be defined as “up” and “down”, “left” and “right”, “forward” and “back”, “rolling left” and “rolling right”, and “turning left” and “turning right”. The mapping of the gyro sensor data to the movements depends on the implementation of the gyro sensors 112 and the definition of the axes in the coordinate system. Other manners of defining movements may be used.

In one illustrative embodiment, evaluating the largest values of movement in any direction based on the sensor data may be used. However, to provide more meaningful interactions, the preferred illustrative embodiment reflects careful study of play movement, particularly in a child's use of a toy. Such study resulted in the conclusion that the sensor data generated cannot be evenly measured across all direction and types of movement. For example, a child's movement of the device 100 in the left or right direction consistently generates higher values of movement (or force) than movement in the up or down direction, partly due to the skeletal and muscular structures of the human arm and wrist. As a result, the application of the present invention prioritizes movement in the following order: up and down; forward and back; rolling left and rolling right; and turning left and turning right. Button presses are prioritized over direction of movement and gestures. Further, each direction of movement is associated with a configurable sensitivity threshold. The sensitivity threshold allows a user to adjust the sensitivity of response universally across all movement in a particular direction. For example, the threshold can be increased as a child gets older and the child's movement values grow. The sensitivity threshold can be decreased to account for injury or disability. The higher the threshold for a direction of movement, the less sensitive the application is to movement in that direction. As the sensor data is received by the application from the device 100, each direction of movement is evaluated. Only when a direction of movement exceeds the threshold for that movement is the feedback associated with the direction of movement triggered. In this illustrative embodiment, for the opposite of the direction of movement, the associated feedback is triggered when the negative of the threshold is exceeded.

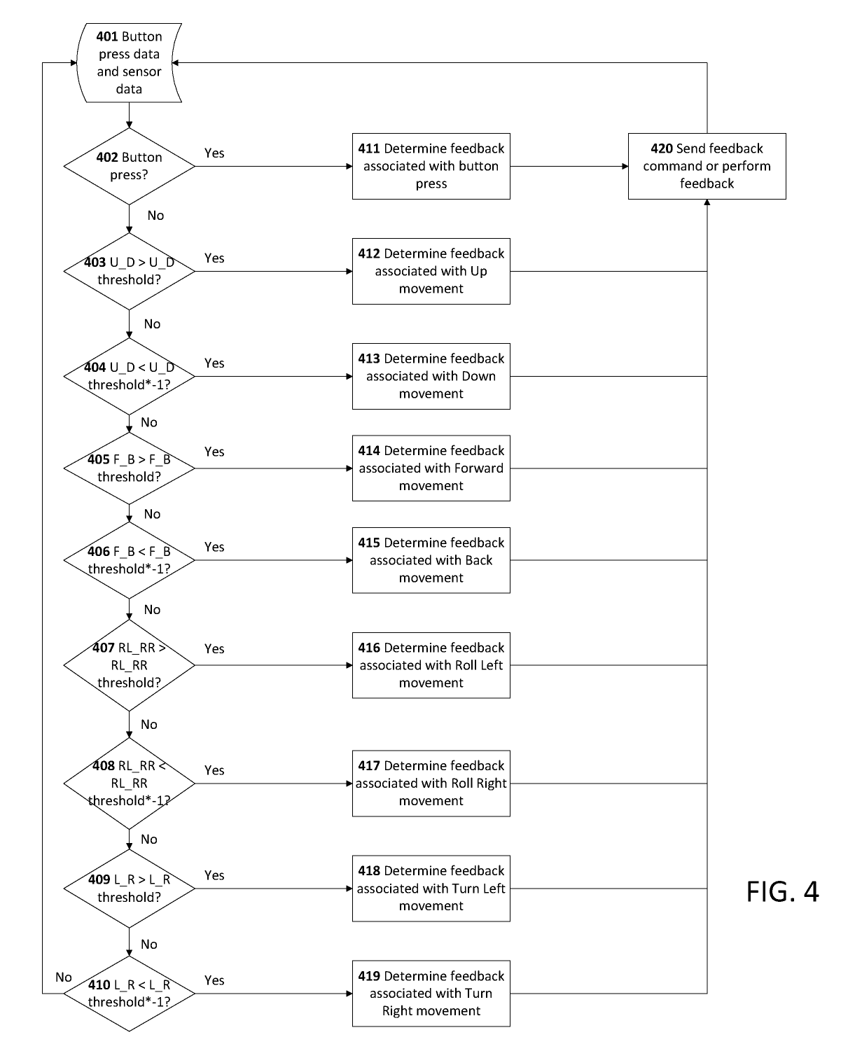

FIG. 4 illustrates the determination of dominant movement according to embodiments of the present invention. In this illustrated embodiment, the priority of movement and threshold values, described above, are applied. First, the application receives user action data from the device 100 (401). If the user action data indicates that one or more button presses were detected (402), then the application determines the feedback associated with the button press (411) and either sends a feedback command to the device 100 to perform the associated feedback or the feedback is executed by the computer system 150 (420). If the user action data indicates no button presses, then the application evaluates the movement data in the following illustrated order.

The application first determines whether the Up and Down direction value (U_D) exceeds the Up and Down threshold value (U_D threshold) (403). If so, then the application determines the feedback associated with the Up movement (412) and either sends a feedback command to the device 100 to perform the associated feedback or the feedback is executed by the computer system 150 (420).

If U_D does not exceed U_D threshold, then the application determines if U_D exceeds the negative of U_D threshold (404). If so, the application determines the feedback associated with the Down movement (413) and either sends a feedback command to the device 100 to perform the associated feedback or the feedback is executed by the computer system 150 (420).

If U_D does not exceed the negative of U_D threshold, then the application determines if the Front and Back direction value (F_B) exceeds the Front and Back Threshold value (F_B threshold) (405). If so, then the application determines the feedback associated with the Forward movement (414) and sends a feedback command to the device 100 to perform the associated feedback or the feedback is executed by the computer system 150 (420).

If F_B threshold does not exceed F_B threshold, then the application determines if F_B exceeds the negative of F_B threshold (406). If so, then the application determines the feedback associated with the Back movement (415) and either sends a feedback command to the device 100 to perform the associated feedback or the feedback is executed by the computer system 150 (420).

If F_B threshold does not exceed the negative of F_B threshold, then the application determines if Rolling Left and Rolling Right direction value (RL_RR) exceeds the Rolling Left and Rolling Right Threshold value (RL_RR threshold) (407). If so, then the application determines the feedback associated with the Roll Left movement (416) and either sends a feedback command to the device 100 to perform the associated feedback or the feedback is executed by the computer system 150 (420).

If RL_RR does not exceed RL_RR threshold, then the application determines if RL_RR exceeds the negative of the RL_RR threshold (408). If so, then the application determines the feedback associated with the Roll Right movement (417) and either sends a feedback command to the device 100 to perform the associated feedback or the feedback is executed by the computer system 150 (420).

If RL_RR does not exceed the negative of RL_RR threshold, then the application determines if Left Turn and Right Turn direction value (L_R) exceeds the Turn Right and Turn Left Threshold value (L_R threshold) (409). If so, then the application determines the feedback associated with the Turn Left movement (418) and either sends a feedback command to the device 100 to perform the associated feedback or the feedback is executed by the computer system 150 (420).

If L_R does not exceed L_R threshold, then the application determines if L_R exceeds the negative of L_R threshold (410). If so, then the application determines the feedback associated with the Turn Right movement (419) and sends a feedback command to the device 100 to perform the associated feedback or the feedback is executed by the computer system 150 (420).

If the action is not a button press and none of the movements exceed their corresponding thresholds, then no feedback command or an idle feedback command is issued by the application or executed by the computer system 150.

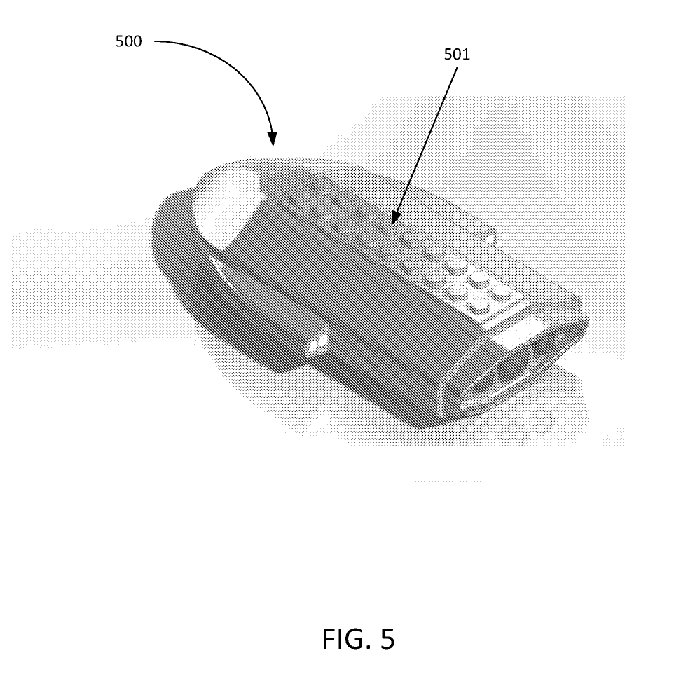

FIG. 5 illustrates an example outer design of the device 100 according to embodiments of the present invention. The illustrative case 500 for device 100 allows the device 100 to be connected to other toys and any “brick” compatible building playset. The user is given numerous ways to add brick compatible pieces onto the device and the ability to use their creativity to control the sounds, images, video playback and other types of interactivity through the device's connection to the application on the computer system 150. In this illustrative embodiment, the casing of the device 100 has at least two one brick-compatible plates 501, built-in, which allows the device 100 to be attached to other toys and/or what a user creates with playsets such as Lego™ Kre-o™, and Mega Bloks™. This enhances the value of the toys by adding sound and application interaction not native to those playsets. The case of the device 100 is designed to be capable of being a toy by itself and independent of other playsets. A user can enjoy the benefits of the device 100 with a connected application and with the ability to attach the device to other brick toys.

In an illustrative embodiment, the application platform that accompanies the device 100 makes gyro sensor 112 interaction easy for developers to build into their games or build new applications around. The application platform may be provided as a Software Development Kit (SDK), which introduces native functionality for syncing via the wireless adaptor 108, receiving the gyro sensor data or button signal and parsing them into actions. The SDK is a collection of libraries native to the application language. In the case of the Android™ platform, the SDK for Android “apps” is a collecting of Java™ classes and examples that include code for: (1) detecting and syncing the computer system 150 (phone, tablet, set top box (STB), or other “smart” device) with the device 100; (2) receiving the gyro sensor data and button signals; and (3) parsing the data or signal and processing them through the algorithm so the developer may code their application to react to the user's movement of the device 100 (dominant movement/gesture or button pressing).

Optionally, the device 100 may include “on board sound”, i.e., the device 100 may have its own memory and speakers with sounds pre-loaded. Also optionally, the device 100 may be designed with a general or generic shape, such as a box.

Although the above embodiments are described in the context of toys, embodiments of the device 100 and computer system 150 may be used in other contexts as well, such as medical or therapeutic devices.

The present invention can take the form of an entirely hardware embodiment, an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer usable or computer readable storage medium providing program code for use by or in connection with a computer or any instruction execution system. For the purposes of this description, a computer usable or computer readable storage medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, point devices, microphones, cameras, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for customizable feedback based on dominant movement of a device, implemented by a computer system, comprising:
(a) synchronizing a device and an application implemented by the computer system, wherein a plurality of movement thresholds is associated with the application;
(b) receiving user action data from the device, wherein the user action data indicates one or more user actions performed with or on the device;
(c) determining a dominant movement based on the user action data and the plurality of movement thresholds;
(d) determining a feedback associated with the dominant movement, wherein the feedback comprises one or more sensory activities to be performed by the device in response to a given user action; and
(e) performing the associated feedback by the device or the computer system.

2. The method of claim 1, wherein the performing (e) comprises:
(e1) when the associated feedback is to be performed by the device, sending, by the computer system, an interaction to the device to perform the associated feedback; and
(e2) when the associated feedback is to be performed by the computer system, executing the associated feedback.

3. The method of claim 1, wherein the determining (c), determining (d), and sending (e) comprises:
(c1) determining that the user action data indicates one or more button presses;
(d1) in response, determining the feedback associated with the one or more buttons; and
(e1) performing the feedback associated with the one or more button presses by the device or the computer system.

4. The method of claim 3, wherein when the user action data does not indicate any button presses, the determining (c) comprises:
(c1) determining the dominant movement based on movement data in the user action data, the movement data indicating movement through space in one or more directions by the device.

5. The method of claim 4, wherein the determining (c1), determining (d), and sending (e) further comprises:
(c1i) determining whether an up and down movement value exceeds an up and down threshold value;
(d1) in response to determining that the up and down movement value exceeds the up and down threshold value, determining the feedback associated with the up and down movement; and
(e1) performing the feedback associated with the up and down movement by the device or the computer system.

6. The method of claim 5, in response to determining that the up and down movement does not exceed the up and down threshold value, the determining (c1), determining (d), and sending (e) further comprises:
(c1ii) determining whether a front and back movement value exceeds a front and back threshold value;
(d2) in response to determining that the front and back movement value exceeds the front and back threshold value, determining the feedback associated with the front and back movement; and
(e2) performing the feedback associated with the front and back movement by the device or the computer system.

7. The method of claim 6, in response to determining that the front and back movement does not exceed the front and back threshold value, the determining (c1), determining (d), and sending (e) further comprises:
(c1iii) determining whether a roll left and roll right movement value exceeds a roll left and roll right threshold value;
(d3) in response to determining that the roll left and roll right movement value exceeds the roll left and roll right threshold value, determining the feedback associated with the roll left and roll right movement; and
(e3) performing the feedback associated with the roll left and roll right movement by the device or the computer system.

8. The method of claim 7, in response to determining that the roll left and roll right movement does not exceed the roll left and roll right threshold value, the determining (c1), determining (d), and sending (e) further comprises:
(c1iv) determining whether a turn left and turn right movement value exceeds a turn left and turn right threshold value;
(d4) in response to determining that the turn left and turn right movement value exceeds the turn left and turn right threshold value, determining the feedback associated with the turn left and turn right movement; and
(e4) performing the feedback associated with the turn left and turn right movement by the device or the computer system.

9. A non-transitory computer readable medium comprising computer readable program code embodied therein, wherein when executed by a processor causes the processor to:
(a) synchronize a device and an application implemented by a computer system, wherein a plurality of movement thresholds is associated with the application;
(b) receive user action data from the device, wherein the user action data indicates one or more user actions performed with or on the device;
(c) determine a dominant movement based on the user action data and the plurality of movement thresholds;
(d) determine a feedback associated with the dominant movement, wherein the feedback comprises one or more sensory activities to be performed by the device or the computer system in response to a given user action; and
(e) performing the associated feedback by the device or the computer system.

10. The medium of claim 9, wherein the perform (e) comprises:
(e1) when the associated feedback is to be performed by the device, send, by the computer system, an interaction to the device to perform the associated feedback; and
(e2) when the associated feedback is to be performed by the computer system, execute the associated feedback.

11. The medium of claim 9, wherein the determine (c), determine (d), and send (e) comprises:
(c1) determine that the user action data indicates one or more button presses;
(d1) in response, determine the feedback associated with the one or more buttons; and
(e1) perform the feedback associated with the one or more button presses by the device or the computer system.

12. The medium of claim 11, wherein when the user action data does not indicate any button presses, the determine (c) comprises:
(c1) determine the dominant movement based on movement data in the user action data, the movement data indicating movement through space in or more directions by the device.

13. The medium of claim 12, wherein the determine (c1), determine (d), and send (e) further comprises:
(c1i) determine whether an up and down movement value exceeds an up and down threshold value;
(d1) in response to determining that the up and down movement value exceeds the up and down threshold value, determine the feedback associated with the up and down movement; and
(e1) perform the feedback associated with the up and down movement by the device or the computer system.

14. The medium of claim 13, in response to determining that the up and down movement does not exceed the up and down threshold value, the determine (c1), determine (d), and send (e) further comprises:
(c1ii) determine whether a front and back movement value exceeds a front and back threshold value;
(d2) in response to determining that the front and back movement value exceeds the front and back threshold value, determine the feedback associated with the front and back movement; and
(e2) perform the feedback associated with the front and back movement by the device or the computer system.

15. The medium of claim 14, in response to determining that the front and back movement does not exceed the front and back threshold value, the determine (c1), determine (d), and send (e) further comprises:
(c1iii) determine whether a roll left and roll right movement value exceeds a roll left and roll right threshold value;
(d3) in response to determining that the roll left and roll right movement value exceeds the roll left and roll right threshold value, determine the feedback associated with the roll left and roll right movement; and
(e3) perform the feedback associated with the roll left and roll right movement by the device or the computer system.

16. The medium of claim 15, in response to determining that the roll left and roll right movement does not exceed the roll left and roll right threshold value, the determine (c1), determine (d), and send (e) further comprises:
(c1iv) determine whether a turn left and turn right movement value exceeds a turn left and turn right threshold value;
(d4) in response to determining that the turn left and turn right movement value exceeds the turn left and turn right threshold value, determine the feedback associated with the turn left and turn right movement; and
(e4) perform the feedback associated with the turn left and turn right movement by the device or the computer system.

17. A system, comprising:
a device, comprising:
a first plurality of sensory components; and
a controller, wherein the controller:
sends user action data to a computer system, the user action data indicating one or more user actions performed with or on the device;
when the device receives a feedback command from the computer system, the feedback command comprising an associated feedback, wherein the associated feedback comprises one or more sensory activities to be performed by the device in response to a given user action, and
performs the associated feedback by activating one or more of the first plurality of sensory components; and
the computer system, comprising:
a second plurality of sensory components;
a processor; and
a non-transitory computer readable medium comprising computer readable program code embodied therein, wherein when executed by a processor causes the processor to:
synchronize the device and an application implemented by the computer system, wherein a plurality of movement thresholds is associated with the application;
receive user action data from the device, wherein the user action data indicates one or more user actions performed with or on the device;
determine a dominant movement based on the user action data and the plurality of movement thresholds;
determine a feedback associated with the dominant movement,
wherein the feedback comprises one or more sensory activities to be performed by the device or the computer system in response to the given user action;
when the associated feedback is to be performed by the device, send the feedback command to the device to perform the associated feedback; and
when the associated feedback is to be performed by the computer system, executing the feedback by the computer system.

18. The system of claim 17, wherein the processor is further caused to:
determine that the user action data indicates one or more button presses; and
in response, determine the feedback associated with the one or more buttons,
wherein the feedback associated with the one or more button presses is performed by the device or the computer system.

19. The system of claim 18, wherein when the user action data does not indicate any button presses, the processor is further caused to:
determine the dominant movement based on movement data in the user action data, the movement data indicating movement through space in or more directions by the device.
